(19) United States
(12) Patent Application Publication
(10) Pub. No.: US 2011/0161841 A1
(43) Pub. Date: Jun. 30, 2011

(54) PSEUDO LOCALIZATION AT RUNTIME

(75) Inventors: Ryan D. Parsell, Langley, WA (US); Timothy John McCracken, Woodinville, WA (US)

(73) Assignee: MICROSOFT CORPORATION, Redmond, WA (US)

(21) Appl. No.: 12/648,582

(22) Filed: Dec. 29, 2009

(51) Int. Cl. G06F 3/048; G06F 15/16; G06F 12/08

(52) U.S. Cl. 715/760; 709/203; 711/118; 711/E12.017

(57) ABSTRACT

A request for a string of an application to be displayed during a Web browser or other client-based application session is received. The string is obtained and modified based on one or more pseudo localization settings associated with the session. The modified string, rather than the obtained string, is returned for display during the session.

### BACKGROUND

As computing devices have become increasingly commonplace throughout the world, it is oftentimes desirable to design applications with interfaces that can be displayed in the local languages of different countries or regions. This typically involves localizing the applications for different countries or regions and the languages spoken in those countries or regions. Although it is desirable to develop applications that can be localized to different countries or regions, developing such applications is not without its problems. One such problem is that developing applications to allow such localization to be performed can be a time-consuming task, resulting in delays in making such applications available to users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a request for a string of an application to be displayed during a client-based application session is received. The string is obtained and modified based on one or more pseudo localization settings associated with the client-based application session. The modified string, rather than the obtained string, is returned for display during the client-based application session.

### BRIEF DESCRIPTION OF THE DRAWINGS

The same numbers are used throughout the drawings to reference like features.

FIG. 1 illustrates an example system implementing the pseudo localization at runtime in accordance with one or more embodiments.

FIG. 2 illustrates an example application service in accordance with one or more embodiments.

FIG. 3 is a flowchart illustrating an example process for pseudo localization at runtime in accordance with one or more embodiments.

FIG. 4 is a flowchart illustrating another example process for pseudo localization at runtime in accordance with one or more embodiments.

FIG. 5 illustrates an example computing device that can be configured to implement the pseudo localization at runtime in accordance with one or more embodiments.

### DETAILED DESCRIPTION

Pseudo localization at runtime is discussed herein. Applications are accessed via a client-based application session, such as a web browser session. A user can input one or more pseudo localization settings associated with the session. Once input, a pseudo localization setting remains associated with the session until the session ends or the setting is overridden by the user. When a string of characters is requested for display as part of an application, the string is obtained and modified during runtime in accordance with the pseudo localization settings associated with the session. The user can input additional pseudo localization settings and/or change pseudo localization settings as he or she desires, allowing the pseudo localization of the application to be changed on-the-fly by the user.

Pseudo localization refers to altering and/or generating strings of characters to simulate aspects of different languages that can be problematic. Pseudo localization can include, for example, adding or removing spaces or punctuation, increasing or decreasing the lengths of strings of characters, and so forth. It should be noted that pseudo localization does not refer to translation of strings of characters from one language into another. Rather, pseudo localization can be used to identify situations where translating strings of characters from one language into another can create problems (e.g., by displaying the translated strings of characters incorrectly or in a manner other than that desired by an application developer).

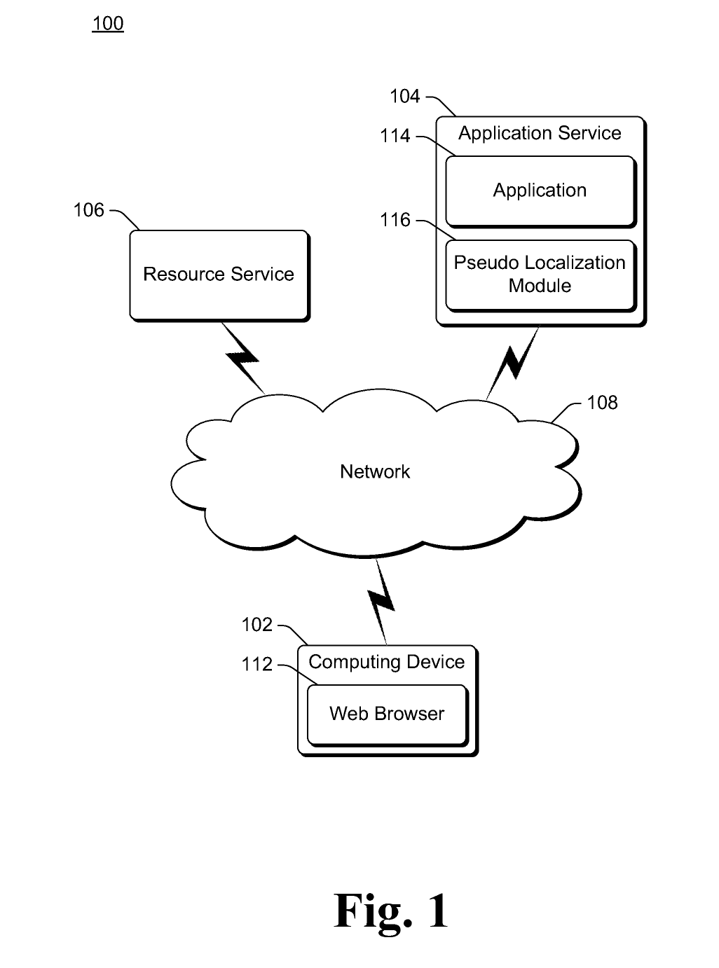

FIG. 1 illustrates an example system 100 implementing the pseudo localization at runtime in accordance with one or more embodiments. System 100 includes a computing device 102, an application service 104, and a resource service 106 that can communicate with one another via a network 108. Network 108 can be a variety of different networks, including the Internet, a local area network (LAN), a telephone network, an intranet, other public and/or proprietary networks, combinations thereof, and so forth.

Computing device 102 can be a variety of different types of devices such as a desktop computer, a laptop or netbook computer, a mobile station, an entertainment appliance, a set-top box communicatively coupled to a display device, a television, a cellular or other wireless phone, a game console, an automotive computer, and so forth. Thus, computing device 102 may range from a full resource device with substantial memory and processor resources (e.g., personal computers, game consoles) to a low-resource device with limited memory and/or processing resources (e.g., traditional set-top boxes, hand-held game consoles).

Application service 104 and resource service 106 can each be implemented as one or more computing devices. Similar to the discussion of computing device 102, services 104 and 106 can each be implemented using one or more of a variety of different types of devices, ranging from full resource devices with substantial memory and processor resources to low-resource devices with limited memory and/or processing resources.

FIG. 1 illustrates one computing device 102, one application service 104, and one resource service 106. However, it is to be appreciated that system 100 can include multiple computing devices 102, multiple application services 104, and/or multiple resource services 106.

Computing device 102 includes a client-based application illustrated as Web browser 112. Although illustrated as a Web browser, it is to be appreciated that other types of applications that are not commonly referred to as Web browsers but that access application service 104 can be used in place of Web browser 112. Web browser 112 communicates with application service 104 via network 108, allowing application 114 to be run by a user of computing device 102. In one or more embodiments, application 114 is a server-based or web-based application that runs at least in part on (or is hosted at least in part on) application service 104, and presents a user interface (UI) to a user of computing device 102 via web browser 112. Application 114 can be, for example, a Web page that displays information to users, and/or a Web page or application that performs additional processing or executing of instructions. Alternatively, application 114 can be an application that is downloaded to computing device 102 and executed at computing device 102. For example, application 114 can be an application written using the JavaScript programming language (a dialect of the ECMAScript standard) or other scripting language, an application written using the Silverlight™ plug-in technology (additional information regarding the Silverlight™ plug-in technology is available from Microsoft Corp. of Redmond, Wash.), and so forth.

Application service 104 also includes a pseudo localization module 116. Although illustrated as separate from application 114, pseudo localization module 116 can alternatively be included as part of application 114. During execution of application 114, one or more strings of characters are requested by Web browser 112 for display on computing device 102. These requests are received by pseudo localization module 116 (e.g., from web browser 112 or from application 114). Pseudo localization module 116 obtains the requested strings from a local data cache or from resource service 106, and returns the requested strings to Web browser 112. Pseudo localization module 116 can also modify these strings in accordance with one or more pseudo localization settings identified by web browser 112. These pseudo localization settings can take a variety of different forms, such as adding spaces or other characters to the beginning and/or ending of strings, changing characters in strings, adding and/or removing characters from strings, and so forth. Various examples of pseudo localization settings are discussed in more detail below.

Web browser 112 specifies a particular one or more pseudo localization settings to be used by pseudo localization module 116. Pseudo localization module 116 receives and maintains a record of the specified pseudo localization settings and modifies subsequently requested strings in accordance with these specified pseudo localization settings. The pseudo localization settings can be changed at any time by web browser 112 specifying the desired change. Accordingly, a user of computing device 102 can quickly and easily request particular pseudo localization settings (or combinations thereof) as desired.

The pseudo localization is performed during a session of Web browser 112 or other client-based application communicating with application service 104. The pseudo localization is also performed during the runtime of application 114, which refers to the time when application 114 is running (including when application 114 begins running), rather than the time when application 114 is being created or compiled. Thus, it can be seen that the pseudo localization is performed by pseudo localization module 116 at runtime of application 114, and that the pseudo localization that is performed can be changed at runtime of application 114.

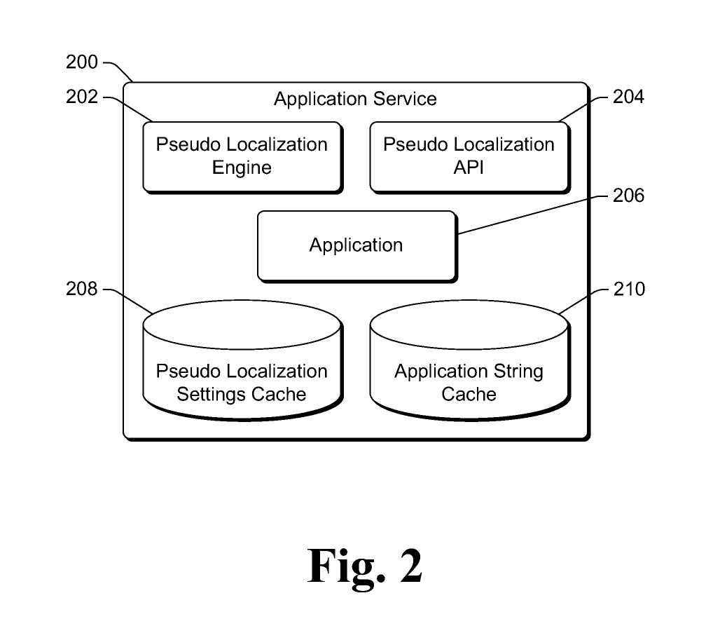

FIG. 2 illustrates an example application service 200 in accordance with one or more embodiments. Application service 200 can be, for example, application service 104 of FIG. 1. Application service 200 includes a pseudo localization engine 202, a pseudo localization application programming interface (API) 204, an application 206, a pseudo localization settings cache 208, and an application string cache 210. Pseudo localization engine 202 and pseudo localization API 204 can be, for example, pseudo localization module 116 of FIG. 1.

Pseudo localization API 204 receives requests for strings to be displayed by a client-based application, such as Web browser 112 of FIG. 1. These requests can be, for example, a uniform resource locator (URL) identifying the requested string. These requests can be received by pseudo localization API 204 from the client-based application itself, or from another component or module (e.g., application 206). In response to a request for a string, pseudo localization API 204 obtains the requested string and communicates the requested string to pseudo localization engine 202. The requested string can be obtained from application string cache 210, which is a local store of strings. This can be, for example, a store of recently requested strings and/or a store of commonly requested strings. If the requested string is not available in cache 210, then pseudo localization API 204 obtains the requested string from a remote service (e.g., resource service 106 of FIG. 1). Although referred to as a requested string, it is to be appreciated that requests can be for multiple strings. For example, a single request can be a request for a set of strings, a request for a web page including multiple strings, and so forth.

Also in response to a request for a string, pseudo localization API 204 checks for any pseudo localization settings associated with the client-based application. A pseudo localization setting can be included as part of the request for a string. In such situations, pseudo localization API 204 communicates an indication of the pseudo localization setting to pseudo localization engine 202. Additionally, pseudo localization API 204 stores an indication of the pseudo localization setting in pseudo localization settings cache 208. Accordingly, a pseudo localization setting included as part of a previous request can be included in cache 208. In such situations, pseudo localization API 204 obtains an indication of the pseudo localization setting from cache 208 and communicates that indication to pseudo localization engine 202.

In one or more embodiments, pseudo localization API 204 persists pseudo localization settings in cache 208 for the duration of the client-based application session. When the client-based application session is closed or terminated (e.g., a current session of Web browser 112 of FIG. 1 is closed), the pseudo localization settings in cache 208 are deleted from cache 208. It is to be appreciated that pseudo localization API 204 can maintain pseudo localization settings in cache 208 for multiple different client-based application sessions concurrently.

It should be noted that although pseudo localization settings cache 208 is illustrated as being included as part of application service 200, pseudo localization settings cache 208 can alternatively be stored in one or more different locations. For example, the pseudo localization settings in cache 208 can be stored on the computing device where the client-based application is running (e.g., stored as a cookie on computing device 102 of FIG. 1).

Accordingly, when a pseudo localization setting is requested for a client-based application session, that pseudo localization setting is used to modify subsequently requested strings. Multiple such pseudo localization settings can be maintained for the client-based application session and used to modify subsequently requested strings. Furthermore, it is to be appreciated that a requested string can be modified in accordance with multiple pseudo localization settings. For example, a requested string can be modified in accordance with both one or more pseudo localization settings included in the request for the string, and one or more pseudo localization settings included in one or more previously received requests for strings.

Pseudo localization engine 202 receives both a requested string and an indication of one or more pseudo localization settings to apply to the requested string. Pseudo localization engine 202 modifies the requested string by performing one or more pseudo localization functions on the requested string. The particular one or more pseudo localization functions are based on the indicated one or more pseudo localization settings to be applied to the requested string. The pseudo localization functions can include, for example, adding spaces or other characters to the beginning and/or ending of a string, changing characters in a string, adding and/or removing characters from a string, and so forth. The modified string is then returned to the client-based application. For example, pseudo localization engine 202 can return the modified string to the client-based application, or pseudo localization engine 202 can provide the modified string to pseudo localization API 204 for return to the client-based application.

Pseudo localization API 204 exposes one or more methods that support various pseudo localization settings. These settings can include, for example, replacing characters, increasing or decreasing the size of a string, forcing space characters into a string, removing or encoding certain characters in a string, adding a character to the beginning or ending of a string, and so forth. These pseudo localization settings can be identified in different manners. In one or more embodiments, pseudo localization settings are identified in a request by adding the following to the end of a request:

?ploc=x

where ?ploc indicates that a pseudo localization setting follows, and x represents a particular one or more pseudo localization settings. The pseudo localization settings are added onto the end of a request for a string. For example, a string request can be as follows:

microsoft.com/ae8fke/data?ploc=x

where the requested string can be found at microsoft.com/ae8fke/data, and the pseudo localization setting is x.

It should be noted that different pseudo localization settings can correspond to a same pseudo localization function, and that one pseudo localization setting can replace a previous pseudo localization setting. For example, a first pseudo localization setting can be to add an asterisk character to the beginning and ending of the requested string. This corresponds to a pseudo localization function that pads the requested string at the beginning and ending with a particular character specified as a parameter of the function. A second, subsequently submitted, pseudo localization setting can be to add a hyphen character to the beginning and ending of the requested string. This second pseudo localization setting corresponds to the same pseudo localization function, except with a different parameter (a hyphen rather than an asterisk). In this situation, the second pseudo localization setting replaces the first pseudo localization setting, so the requested string is padded with a hyphen at the beginning and ending rather than with an asterisk. However, it should be noted that the two pseudo localization settings could be submitted together (e.g., chained or nested together as discussed below), in which case the requested string is padded with a hyphen and an asterisk at the beginning and ending.

The pseudo localization settings can be grouped together in a variety of different manners. In one or more embodiments, the pseudo localization settings can be nested together. Nesting together the pseudo localization settings indicates that one pseudo localization function is to be performed on the result of a different pseudo localization function having been performed on the requested string. For example, a first pseudo localization function can be performed to force space characters into the requested string, resulting in a partially modified string. A second pseudo localization function can then be performed to add a single character to the beginning and ending of the partially modified string, resulting in the modified string to be returned to the client-based application.

Additionally, in one or more embodiments the pseudo localization settings can be chained together, indicating that the results of applying multiple pseudo localization settings are to be appended together. For example, a first pseudo localization function can be performed to force space characters into the requested string, resulting in a first partially modified string. A second pseudo localization function can be performed to add a single character to the beginning and ending of the requested string, resulting in a second partially modified string. The first and second partially modified strings can then be appended together, one after the other (e.g., the first partially modified string followed by the second partially modified string), resulting in the modified string to be returned to the client-based application.

In addition to persisting pseudo localization settings in cache 208, one or more macros can also be defined. A macro refers to a collection of two or more pseudo localization settings applied in a particular manner (e.g., nested together and/or chained together). The macro has an associated name, and the collection of pseudo localization settings that are included in the macro can be identified by requesting a pseudo localization setting for that name. For example, using the ?ploc=x format discussed above, x can refer to a name of a macro.

A macro can be defined in a variety of different manners. In one or more embodiments, a request identifying the collection of pseudo localization settings to be included in a macro as well as the name of the macro is received from the client-based application. Alternatively, information identifying the collection of pseudo localization settings to be included in the macro as well as the name of the macro are received in different manners, such as from an application developer, an administrator of application service 200, and so forth.

In one or more embodiments, pseudo localization engine 202 compiles a pseudo localization function in accordance with the requested pseudo localization settings when a request to apply a particular one or more pseudo localization settings is received. This compiling refers to generating an object hierarchy to process strings by applying the requested pseudo localization settings. The compiled pseudo localization function is maintained by pseudo localization engine 202 for subsequent use in modifying requested strings, thereby allowing pseudo localization engine 202 to modify subsequently requested strings more quickly. These compiled pseudo localization functions are persisted for the duration of the client-based application session (analogous to the persisting of pseudo localization settings in cache 208 discussed above).

One or more pseudo localization functions can also be compiled and maintained for each macro, such as in pseudo localization settings cache 208. The pseudo localization function for a macro is similar to the pseudo localization function compiled when a request to apply particular pseudo localization settings is received. However, the pseudo localization function for a macro is persisted across multiple client-based application sessions rather than just for the duration of a single session. Accordingly, the pseudo localization function for a macro is available and accessible for multiple client-based application sessions. The macro can define a collection of pseudo localization settings and/or a collection of pseudo localization functions.

In one or more embodiments, application 206 can operate in a test environment or a non-test (e.g., normal) environment. An indication of whether application 206 is operating in a test or non-test environment is associated with application 206, such as being indicated in a flag value of application 206. The indication of whether application is operating in a test or non-test environment can be set in different manners, such as by a developer of application 206, by an administrator of application service 200, and so forth. Pseudo localization engine 202 modifies requested strings when application 206 is operating in a test environment, but does not modify requested strings when application 206 is operating in a non-test environment. Pseudo localization settings included in requests received by pseudo localization API 204 when application 206 is operating in a non-test environment are ignored by pseudo localization API 204 and pseudo localization engine 202.

In one or more embodiments, application 206 is a server-based or web-based application that runs at least in part on (or is hosted at least in part on) application service 200. As requests for scripts of application 206 are received from the client-based application, the requests are modified by pseudo localization engine 202 as discussed above.

In other embodiments, application 206 is an application that is downloaded to another computing device (e.g., computing device 102 of FIG. 1) and executed at that computing device. In such situations, the scripts of application 206 that could be requested are downloaded as part of the process of downloading application 206, and are modified by pseudo localization engine 202 prior to being downloaded. In such situations, if a pseudo localization setting is changed (e.g., modified, added, etc.), the scripts of application are modified to reflect this change and re-downloaded to that computing device.

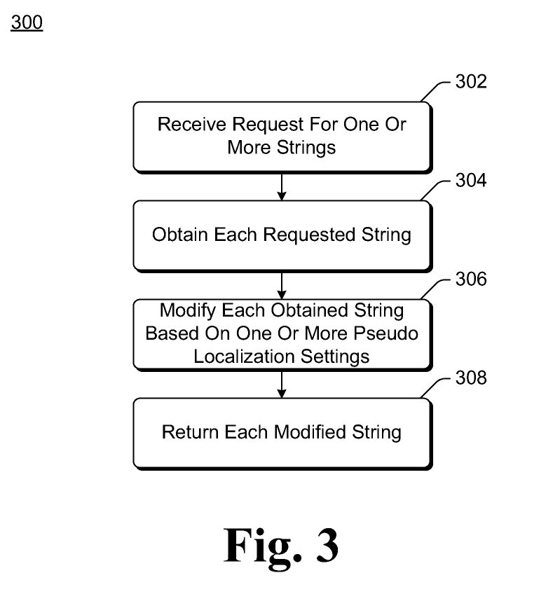

FIG. 3 is a flowchart illustrating an example process 300 for pseudo localization at runtime in accordance with one or more embodiments. Process 300 is carried out by a pseudo localization module, such as pseudo localization module 116 of FIG. 1, or pseudo localization engine 202 and pseudo localization API 204 of FIG. 2, and can be implemented in software, firmware, hardware, or combinations thereof. Process 300 is shown as a set of acts and is not limited to the order shown for performing the operations of the various acts. Process 300 is an example process for pseudo localization at runtime; additional discussions of pseudo localization at runtime are included herein with reference to different figures.

In process 300, a request for one or more strings is received (act 302). This request is received from a client-side application, such as a Web browser, and is a request for a string of an application at an application service. The request is received during runtime of the application at the application service. In other words, the request is received while the application is running or when running of the application is requested, rather than being pre-compiled into the application. As discussed above, this request can be a request for a single string or a request for multiple strings.

Each requested string is obtained (act 304). Each requested string can be obtained from a local store or from a remote service as discussed above.

Each obtained string is modified based on one or more pseudo localization settings (act 306). These one or more pseudo localization settings are pseudo localization settings associated with the client-side application session. As discussed above, these pseudo localization settings can be included as part of the request received in act 302, and/or can be included as part of a previously received request.

Each modified string is returned (act 308). Thus, in response to a request for a particular string, the modified string is returned for display by the client-side application rather than the requested string.

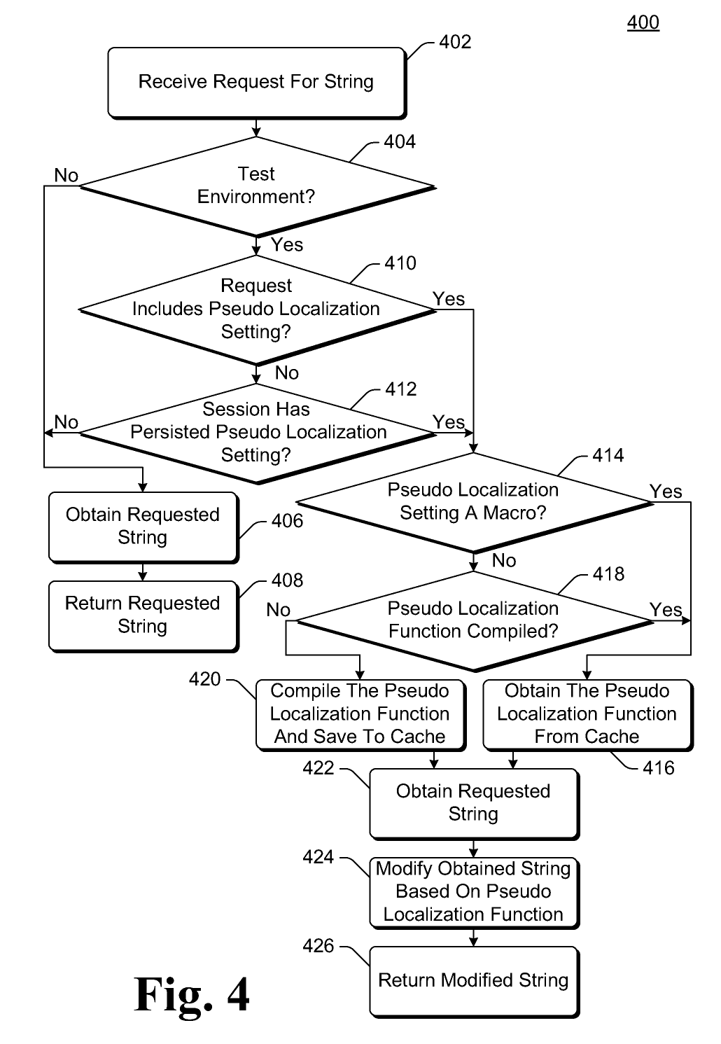

FIG. 4 is a flowchart illustrating another example process 400 for pseudo localization at runtime in accordance with one or more embodiments. Process 400 is carried out by a pseudo localization module, such as pseudo localization module 116 of FIG. 1, or pseudo localization engine 202 and pseudo localization API 204 of FIG. 2, and can be implemented in software, firmware, hardware, or combinations thereof. Process 400 is shown as a set of acts and is not limited to the order shown for performing the operations of the various acts. Process 400 is an example process for pseudo localization at runtime; additional discussions of pseudo localization at runtime are included herein with reference to different figures.

In process 400, a request for a string is received (act 402). This request is received from a client-side application, such as a Web browser, and is a request for a string of an application at an application service. The request is received during runtime of the application at the application service. In other words, the request is received while the application is running or when running of the application is requested, rather than being pre-compiled into the application. Although a single string is referred to in process 400, it is to be appreciated that multiple strings can be requested, obtained, and modified in process 400.

A check is made as to whether the application for which the string is requested is running in a test environment (act 404). This can be determined in different manners as discussed above, such as by checking a flag value of the application.

If the application is not running in a test environment, then the requested string is obtained (act 406) and returned to the requesting client-side application (act 408). The requested string can be obtained from a local store or a remote service as discussed above.

However, if the application is running in a test environment, then a check is made as to whether the request includes a pseudo localization setting (act 410). The request can include a pseudo localization setting in different manners, such as using the ?ploc=x format discussed above.

If the request does not include a pseudo localization setting, then a check is made as to whether the client-side application session has a persisted pseudo localization setting (act 412). Such a persisted pseudo localization is maintained, for example, in a pseudo localization settings cache as discussed above.

If the request does not include a pseudo localization setting and the client-side application session does not have a persisted pseudo localization setting, then the requested string is obtained (act 406) and returned to the requesting client-side application (act 408).

However, if the request includes a pseudo localization setting and/or the client-side application session has a persisted pseudo localization setting, then a check is made as to whether the pseudo localization setting identifies a macro (act 414). A determination of whether the pseudo localization setting identifies a macro can be made in different manners, such as by using a different format for macros (e.g., ?plocmacro=x), checking whether the requested setting matches a name of a macro, and so forth.

If the pseudo localization setting identifies a macro, then the pseudo localization function or functions for the macro are obtained from the cache (act 416). This cache can be, for example, the pseudo localization settings cache discussed above.

However, if the pseudo localization setting does not identify a macro, then a check is made as to whether the pseudo localization function has already been compiled (act 418). If the pseudo localization function has already been compiled, then the previously compiled pseudo localization function is obtained from the cache (act 416). If the pseudo localization function has not already been compiled, then the pseudo localization function is compiled and saved to the cache (act 420). This cache can be, for example, the pseudo localization settings cache discussed above.

Regardless of whether the pseudo localization function is compiled in act 420 or a previously compiled pseudo localization function is obtained in act 416, the requested string is obtained (act 422). The requested string can be obtained from a local store or a remote service as discussed above.

The obtained string is modified based on the pseudo localization function (act 424). This pseudo localization function modifies the obtained string in accordance with various different pseudo localization settings as discussed above.

The modified string is returned (act 426). Thus, in response to a request for a particular string, the modified string is returned for display by the client-side application rather than the requested string.

Although process 400 is discussed with reference to a pseudo localization function, it is to be appreciated that multiple pseudo localization functions, based on multiple pseudo localization settings, can be used to modify the obtained string.

Returning to FIG. 2, pseudo localization API 204 can expose a variety of different methods or functions that support various pseudo localization settings. These different methods or functions can be invoked by a request from a client-based application, causing pseudo localization engine 202 to perform the appropriate pseudo localization functions in accordance with the pseudo localization settings. In the following, several example functions are discussed in additional detail. It is to be appreciated that these are examples, and that other functions can be used to implement the pseudo localization at runtime discussed herein.

It should be noted that, for various ones of the following functions, the string referred to for the functions can be the original string. The original string refers to the string requested by the client-side application without any modification performed to it (e.g., the string obtained from application string cache 210 of FIG. 2, or from resource service 106 of FIG. 1). The string referred to for the functions can also be a string that is returned by another function (e.g., a partially modified string). The string that is to be modified by the function can be specified as a parameter of the function. If no string is specified as the parameter, then the original string is used by default.

Character Set Function. The Character Set function replaces the characters in a string with a predefined set as specified in a parameter of the Character Set function. A variety of different predefined sets of characters can be used, such as characters from an Asian language (e.g., Chinese characters, Korean characters, etc.), script characters, bi-directional characters (e.g., Hebrew characters, Arabic characters, etc.), and so forth. For bi-directional characters, the ordering of the characters in the script are also reversed (e.g., the characters from left-to-right in the string become right-to-left in the modified string). An example format for invoking the Character Set function is:

?ploc=chs([argument])

where argument refers to the desired predefined set of characters that are to be used to replace the characters in the original string. Another example format for invoking the Character Set function is:

?ploc=chs([argument],[nested function])

where nested function refers to one or more functions, and argument refers to the desired predefined set of characters that are to be used to replace the original characters in the partially modified string resulting from performing the one or more functions specified by nested function.

Expand Function. The Expand function increases or decreases the size of the string by a given percentage specified in a parameter of the Expand function. The given percentage can be a whole number, and can be 100%, greater than 100%, or less than 100%. For example, a given percentage of 120% indicates the size of the string is to be increased by 20%. A size of 100% indicates that the original string size is to be used (e.g., the size of the string as it is obtained or provided to the pseudo localization engine). When increasing the size of the string, the characters from the string itself are used (e.g., copying characters from the beginning of the string and adding them to the end of the string until the desired string size is obtained). When decreasing the size of the string, some characters (e.g., characters from the ending of the string) are deleted from the string. An example format for invoking the Expand function is:

?ploc=exp([percentage])

where percentage refers to the given percentage by which the size of the original string is to be increased or decreased. Another example format for invoking the Expand function is:

?ploc=exp([percentage],[nested function])

where nested function refers to one or more functions, and percentage refers to the given percentage by which the size of the partially modified string resulting from performing the one or more functions specified by nested function is to be increased or decreased.

Break Function. The Break function forces a space character to be inserted into the string at particular intervals as specified in a parameter of the Break function. For example, a specified interval of 5 indicates that a space character is to be inserted into the string after every 5^{th} character in the string. An example format for invoking the Break function is:

?ploc=brk([count])

where count refers to the particular interval at which the space character is to be inserted in the original string. Another example format for invoking the Break function is:

?ploc=brk([count],[nested function])

where nested function refers to one or more functions, and count refers to the particular interval at which the space character is to be inserted in the partially modified string resulting from performing the one or more functions specified by nested function.

Modify Function. The Modify function removes or encodes certain types of characters from the string as specified in a parameter of the Modify function. Example parameters of the Modify function include a “wht” parameter, a “pnc” parameter, and an “htm” parameter. The “wht” parameter specifies that all white space that allows wrapping is to be removed, including space characters, tab characters, carriage return characters, and line feed characters. The “pnc” parameter specifies that punctuation (e.g., commas, periods, hyphens, etc.) is to be removed from the string. The “htm” parameter specifies that HTML (HyperText Markup Language) in the string is to be encoded so that it is visible when displayed. This results in the actual HTML code being displayed as part of the string rather than the formatting or other result of the HTML on the string being displayed. An example format for invoking the Modify function is:

?ploc=mod([argument])

where argument refers to one of the following three parameters: the “wht” parameter, the “pnc” parameter, and the “htm” parameter. Another example format for invoking the Modify function is:

?ploc=mod([argument],[nested function])

where nested function refers to one or more functions, and argument refers to one of the following three parameters: the “wht” parameter, the “pnc” parameter, and the “htm” parameter.

Pad Function. The Pad function adds a single character to the beginning and ending of the string. The single character is specified as a parameter of the Pad function. The Pad function allows, for example, an asterisk to be added to the beginning and ending of the string, a dollar sign to be added to the beginning and ending of the string, and so forth. An example format for invoking the Pad function is:

?ploc=pad([characters])

where characters refers to the single character that is to be added to the beginning and ending of the original string. Another example format for invoking the Pad function is:

?ploc=pad([characters],[nested function])

where nested function refers to one or more functions, and characters refers to the single character that is to be added to the beginning and ending of the partially modified string resulting from performing the one or more functions specified by nested function.

Random Characters Function. The Random Characters function picks and returns a number of randomly generated characters that can be displayed. The number of characters returned is specified as a parameter of the Random Characters function. The characters can be randomly generated from a set of displayable characters in accordance with a variety of different conventional random number generation or pseudo random number generation techniques. An example format for invoking the Random Characters function is:

?ploc=rnd([count])

where count refers to the number of randomly generated characters that are to be returned.

Original String Function. The Original String function returns the original string. The original string refers to the string requested by the client-side application without any modification performed to it. An example format for invoking the Original String function is:

?ploc=org( )

where no parameters are included in the Original String function.

Preferred Characters Function. The Preferred Characters function returns a number of characters from a predefined set of characters. The number of characters returned is specified as a parameter of the Preferred Characters function. The predefined set of characters can be predefined in different manners, such as by a developer of an application, an administrator of an application service, a developer of a pseudo localization module, and so forth. The predefined set of characters typically includes characters that oftentimes create problems when translating a string into a different language. The characters returned can be selected from the predefined set of characters in different manners (e.g., from the beginning of the predefined set of characters, randomly from the predefined set of characters, and so forth). An example format for invoking the Preferred Characters function is:

?ploc=prf([count])

where count refers to the number of characters from the predefined set of characters that are to be returned.

Literal Function. The Literal function returns the parameter passed to the Literal function. Typically, the parameter passed to the Literal function is a string. An example format for invoking the Literal function is:

?ploc=lit([string])

where string refers to the string that is to be returned.

These example functions allow various nesting of pseudo localization settings as discussed above. The following are some examples using the functions discussed above.

One example is:

?ploc=exp(120,org( ))

that returns a modified string that is the original string increased in size by 20%.

Another example is:

?ploc=chs(ext,rnd(10))

that returns a modified string that is ten randomly generated characters replaced with characters from a predefined set of characters identified as “ext”.

Yet another example is:

?ploc=pad(*,chs(ext1,exp(150)))

that returns a modified string that is formed by increasing the size of the original string by 50% resulting in a first partially modified string, replacing the characters in the first partially modified string with a predefined set of characters identified as “ext1” resulting in a second partially modified string, and adding an asterisk character to the beginning and ending of the second partially modified string.

These example functions also allow chaining of pseudo localization settings to be specified. Chaining of pseudo localization settings can be specified by using a particular character (e.g., a semicolon) to separate the functions being chained together. For example:

?ploc=exp(120,org( ));chs(ext,rnd(10))

returns a modified string that is the original string increased in size by 20%, appended to the end of which is a partially modified string that is ten randomly generated characters replaced with characters from a predefined set of characters identified as “ext”.

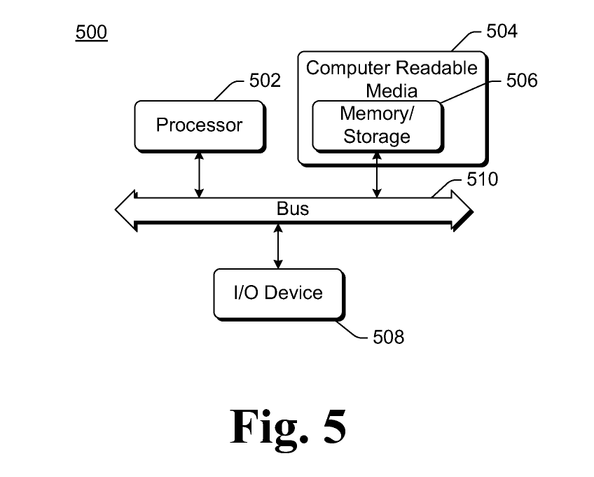

FIG. 5 illustrates an example computing device 500 that can be configured to implement the pseudo localization at runtime in accordance with one or more embodiments. Computing device 500 can be, for example, computing device 102 of FIG. 1, or can implement at least part of application service 104 or resource service 106 of FIG. 1, or application service 200 of FIG. 2.

Computing device 500 includes one or more processors or processing units 502, one or more computer readable media 504 which can include one or more memory and/or storage components 506, one or more input/output (I/O) devices 508, and a bus 510 that allows the various components and devices to communicate with one another. Computer readable media 504 and/or one or more I/O devices 508 can be included as part of, or alternatively may be coupled to, computing device 500. Bus 510 represents one or more of several types of bus structures, including a memory bus or memory controller, a peripheral bus, an accelerated graphics port, a processor or local bus, and so forth using a variety of different bus architectures. Bus 510 can include wired and/or wireless buses.

Memory/storage component 506 represents one or more computer storage media. Component 506 can include volatile media (such as random access memory (RAM)) and/or nonvolatile media (such as read only memory (ROM), Flash memory, optical disks, magnetic disks, and so forth). Component 506 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 502. It is to be appreciated that different instructions can be stored in different components of computing device 500, such as in a processing unit 502, in various cache memories of a processing unit 502, in other cache memories of device 500 (not shown), on other computer readable media, and so forth. Additionally, it is to be appreciated that the location where instructions are stored in computing device 500 can change over time.

One or more input/output devices 508 allow a user to enter commands and information to computing device 500, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer readable memory devices, further description of which may be found with reference to FIG. 5. The features of the pseudo localization at runtime techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in a device, the method comprising:
receiving, for a client-based application session, a request for a string of an application to be displayed during the client-based application session;
obtaining the string;
modifying the string based on one or more pseudo localization settings associated with the client-based application session; and
returning the modified string rather than the obtained string for display during the client-based application session.

2. A method as recited in claim 1, wherein the one or more pseudo localization settings are associated with the client-based application session by being included as part of the request.

3. A method as recited in claim 2, further comprising maintaining the one or more pseudo localization settings in a cache, and using the one or more pseudo localization settings to modify additional requested strings during the client-based application session but not during other client-based application sessions.

4. A method as recited in claim 1, wherein the one or more pseudo localization settings are associated with the client-based application session as having been included as part of a previous request received during the client-based application session.

5. A method as recited in claim 1, wherein one of the one or more pseudo localization settings replaces a previous pseudo localization setting associated with the client-based application session, the one pseudo localization setting and the previous localization setting corresponding to a same pseudo localization function but having different parameters.

6. A method as recited in claim 1, wherein a first of the one or more pseudo localization settings is associated with the client-based application session by being included as part of the request, and a second of the one or more pseudo localization settings is associated with the client-based application session by having been included as part of a previous request received during the client-based application session.

7. A method as recited in claim 1, wherein obtaining the string comprises obtaining the string from a remote resource service.

8. A method as recited in claim 1, wherein the one or more pseudo localization settings include a first pseudo localization setting nested within a second pseudo localization setting indicating that a first pseudo localization function is to be performed on the string to generate a partially modified string, and that a second pseudo localization function is to be performed on the partially modified string.

9. A method as recited in claim 1, wherein the one or more pseudo localization settings include multiple pseudo localization settings chained together one after another indicating that a first pseudo localization function is to be performed on the string to generate a first partially modified string, that a second pseudo localization function is to be performed on the string to generate a second partially modified string, and that the first partially modified string and the second partially modified string are to be appended together to form the modified string.

10. A method as recited in claim 1, wherein the one or more pseudo localization settings are identified by a macro that includes multiple pseudo localization functions that are to be performed on the string.

11. A method as recited in claim 1, wherein the client-based application session comprises a Web browser session.

12. One or more computer storage media having stored thereon multiple instructions execution of which by one or more processors of a first computing device cause the one or more processors to:
receive, during a Web browser session with a second computing device, a request for a string of an application to be displayed during the Web browser session;
obtain the string;
modify the string using one or more pseudo localization functions in accordance with one or more pseudo localization settings associated with the Web browser session; and
return the modified string to the second computing device for display in place of the string.

13. One or more computer storage media as recited in claim 12, wherein to modify the string using one or more pseudo localization functions is to insert a space character into the string at particular intervals specified by one of the one or more pseudo localization settings.

14. One or more computer storage media as recited in claim 12, wherein to modify the string using one or more pseudo localization functions is to remove from the string white space that allows wrapping.

15. One or more computer storage media as recited in claim 12, wherein to modify the string using one or more pseudo localization functions is to display HyperText Markup Language code in the string as the HyperText Markup Language code rather than formatting the string based on the HyperText Markup Language code.

16. One or more computer storage media as recited in claim 12, wherein the one or more pseudo localization settings are associated with the Web browser session by being included as part of the request.

17. One or more computer storage media as recited in claim 16, wherein the multiple instructions further cause the one or more processors to maintain the one or more pseudo localization settings in a cache, and use the one or more pseudo localization settings to modify additional requested strings during the Web browser session but not during other Web browser sessions.

18. One or more computer storage media as recited in claim 12, wherein the one or more pseudo localization settings include a first pseudo localization setting nested within a second pseudo localization setting indicating that a first pseudo localization function is to be performed on the string to generate a partially modified string, and that a second pseudo localization function is to be performed on the partially modified string.

19. One or more computer storage media as recited in claim 12, wherein the one or more pseudo localization settings include multiple pseudo localization settings chained together one after another indicating that a first pseudo localization function is to be performed on the string to generate a first partially modified string, that a second pseudo localization function is to be performed on the string to generate a second partially modified string, and that the first partially modified string and the second partially modified string are to be appended together to form the modified string.

20. A method implemented in a device, the method comprising:
receiving, for a Web browser session, a request for a string of an application to be displayed during the Web browser session, the request identifying multiple pseudo localization settings;
checking whether the multiple pseudo localization settings associated with the Web browser session are a macro;
obtaining, if the multiple pseudo localization settings identify a macro, one or more compiled pseudo localization functions for the multiple pseudo localization settings from a cache;
if the multiple pseudo localization settings do not identify a macro, then:
checking whether one or more pseudo localization functions for the multiple pseudo localization settings has been compiled,
obtaining, if the one or more pseudo localization functions have been compiled, the one or more compiled pseudo localization functions from the cache, and
compiling, if the one or more pseudo localization functions have not been compiled, the one or more pseudo localization functions;
obtaining the requested string;
modifying the requested string based on the one or more compiled pseudo localization function; and
returning the modified string rather than the string for display during the Web browser session.
